(19) United States
(12) Patent Application Publication
(10) Pub. No.: US 2004/0105945 A1
(43) Pub. Date: Jun. 3, 2004

(54) Peroxide cured styrene butadiene for brake hose

(76) Inventor: LaDonna J. Jerrell, Murray, KY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 09/962,689

(22) Filed: Sep. 25, 2001

(51) Int. Cl. B32B 1/08

(52) U.S. Cl. 428/36.8; 428/36.91

(57) ABSTRACT

A multilayer brake hose is described. The hose includes an elastomeric inner layer or core tube, and a first reinforcing layer disposed around and bonded to the inner layer. The hose also includes an elastomeric intermediate layer overlying the first reinforcing layer, a second reinforcing layer overlying the elastomeric intermediate layer, and an elastomeric protective cover layer disposed over the second reinforcing layer. The inner layer includes styrene butadiene rubber (SBR) cured with a peroxide. The peroxide-cured SBR has compression set characteristics similar to sulfur-cured SBR, while exhibiting better adhesion to wound or braided fibers used in the reinforcing layers.

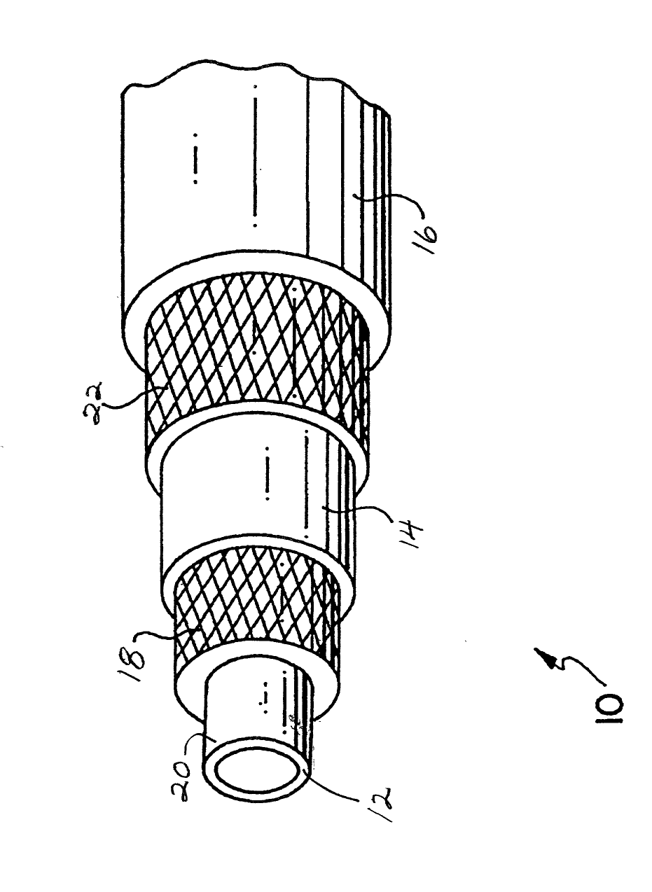

### BACKGROUND OF THE INVENTION

1. Field of the Invention

This invention pertains to an improved high-pressure rubber hose for use in automotive brake systems, and more particularly, to a multilayer elastomeric brake hose incorporating braided reinforcement layers and displaying improved interlayer adhesion and compression set.

2. Discussion of Prior Art

Operating requirements for high-pressure automotive brake hoses continue to increase, requiring improvements in the structure of brake hoses and in the materials used to fabricate them. Current automotive brake hoses typically comprise five layers—three elastomeric layers, including an inner layer or core tube, an intermediate layer, and an outer layer or cover—and two reinforcing layers of wound or braided fiber. The fiber reinforcing layers are disposed between the inner and intermediate elastomeric layers and between the intermediate and outer elastomeric layers.

Conventional automotive brake hoses include elastomeric layers made of ethylene propylene diene monomer (EPDM) rubber. EPDM rubber exhibits many desirable properties including good resistance to intrusion by water, which may dilute and lower the boiling point of brake fluid within the hose. In addition, many fibers used in the reinforcing layers, including braided polyvinyl alcohol fibers coated with a resorcinol-formaldehyde latex (RFL) adhesive, bond well to EPDM rubber. The reinforcing layers interact and cooperate with the EPDM layers to help cushion the intermediate and outer layers of EPDM and to strengthen the hose against excessive volumetric expansion.

However, conventional brake hoses made with EPDM rubber suffer certain disadvantages. For example, EPDM has high compression set and its modulus of elasticity changes greatly with temperature. To address these concerns, brake hose manufacturers have suggested curing EPDM with peroxides. But, peroxide-vulcanized EPDM is difficult to knead, cannot be smoothly extruded, and exhibits generally poor processability.

The present invention is directed to overcoming, or at least minimizing, one or more of the problems set forth above.

### SUMMARY OF THE INVENTION

The present invention provides a multilayer hose, which includes an elastomeric core tube comprised of a peroxide-cured styrene butadiene rubber, a first reinforcing layer that is bonded to an outer surface of the elastomeric core tube, and an elastomeric intermediate layer that overlies or covers the first reinforcing layer. The multilayer hose also includes a second reinforcing layer that overlies the elastomeric intermediate layer, and an elastomeric outer layer that overlies the second reinforcing layer.

One aspect of the present invention provides a multilayer hose, which includes an elastomeric core tube comprised of a peroxide-cured styrene butadiene rubber, a braided reinforcing layer that is disposed on and is bonded to the elastomeric core tube, and an elastomeric outer layer that overlies the braided reinforcing layer.

Another aspect of the present invention provides a multilayer hose, which includes an elastomeric core tube comprised of styrene butadiene rubber, and a first reinforcing layer that is bonded to an outer surface of the elastomeric core tube. The multilayer tube also includes an elastomeric intermediate layer that overlies the first reinforcing layer, a second reinforcing layer that overlies the elastomeric intermediate layer, and an elastomeric outer layer that overlies the second reinforcing layer. The styrene butadiene rubber comprises from about thirty to about fifty percent by weight of the elastomeric core tube and is cured with a peroxide.

Still another aspect of the present invention provides a multilayer hose, which includes an elastomeric core tube comprised of a peroxide-cured styrene butadiene rubber, and a first reinforcing layer that is bonded to an outer surface of the elastomeric core tube. The multilayer hose also includes an elastomeric intermediate layer that overlies the first reinforcing layer, a second reinforcing layer that overlies the elastomeric intermediate layer, and an outer layer that overlies the second reinforcing layer. The elastomeric core tube comprises from about thirty to about fifty percent by weight of styrene butadiene rubber, from about thirty-five to about fifty percent by weight of one or more particulate fillers, and from about 0.5 to about 18.5 percent by weight of one or more processing aids.

The disclosed multilayer hoses are especially useful as automotive brake hoses. The use of peroxide-cured SBR in the elastomeric core tube results in better compression set characteristics than similar EPDM-type hoses and lower material costs. Unlike sulfur-cured SBR, peroxide-cured SBR maintains good adhesion to textiles (wound or braided fibers) used in the reinforcing layers, and can be used with many types of brake fluid.

### BRIEF DESCRIPTION OF THE DRAWING

The drawing FIGURE is a perspective side view of a multilayer hose (not to scale).

### DETAILED DESCRIPTION OF THE EMBODIMENTS

The drawing FIGURE shows a perspective side view of an embodiment of a brake hose 10 made in accordance with the invention. The hose 10 includes three elastomeric layers and two wound or braided fiber reinforcing layers. The hose 10 includes an elastomeric inner layer 12 or core tube, which is comprised of a peroxide-cured styrene butadiene rubber (SBR). The elastomeric inner layer 12 defines a flexible and approximately cylindrical flow path for conveying brake fluids within automobiles. The hose 10 also includes an elastomeric intermediate layer 14 and an elastomeric outer layer 16 or cover, which are comprised of neoprene rubber. The outer layer 16 protects the hose 10 from moisture intrusion, cuts, abrasions and other environmental hazards such as oils and solvents.

The hose 10 includes a first reinforcing layer 18, which is bonded to an outer surface 20 of the elastomeric inner layer 12. The hose 10 also includes a second reinforcing layer 22, which is interposed between the intermediate 14 and the outer 16 elastomeric layers. Both reinforcing layers 18, 22 typically comprise wound or braided fiber, which prevent excessive expansion of the inner layer 12 when the core (brake) fluid is under pressure. Useful fibers include rayon fiber, especially when coated with a resorcinol-formaldehyde latex (RFL) adhesive.

Prior to crosslinking, styrene butadiene rubber comprises from about thirty to about fifty percent by weight of the layer 12. SBR is typically made by emulsion or solution polymerization of butadiene and styrene, usually in the presence of an initiator and catalyst. To achieve the requisite resiliency, styrene butadiene rubber (SBR) is crosslinked, and traditionally has been cured or vulcanized using sulfur-containing compounds. However, as shown in the Example below, sulfur-cured SBR has several disadvantages when used in automotive brake hoses, including poor adhesion to the fibers (textiles) used in the reinforcement layers 18, 22 of the hose 10. Suitable SBR is available from a variety of manufactures, including Ameripol-Sinpol, which markets a particularly useful SBR having industry designation 1503 SBR.

Table 1 lists components of one embodiment of the layer 12. As can be seen in Table 1, the elastomeric inner layer 12 may include, in addition to SBR, various particulate fillers, processing aids, curing activators, antioxidants, curing agents, and the like. Useful particulate fillers include carbon black and silica, which serve as extenders and provide reinforcement. Carbon black may comprise from about thirty to about forty percent by weight of the layer 12, and silica may comprise from about five to about ten percent by weight of layer 12.

TABLE 1
Composition of an Inner Layer of the Brake Hose

| Component | Wt. % | Trade Name | Supplier |
|---|---|---|---|
| SBR | 30-50 | 1503 SBR | Ameripol-Sinpol |
| Carbon Black | 30-40 | CARBON | Cabot |
| | | BLACK N-550 | |
| Silica | 5-10 | HISIL 243 L.D. | Harwick |
| Trans-poly- | 5-10 | VEST ENAMER-80 | Crenova |
| octanamer | | | |
| Polybutadiene | 3-6 | TAKTENE 1220 | Bayer Fibers- |
| | | | Organic & Rubber |
| | | | Division |
| Zinc Oxide | 1-4 | | Bayer Fibers- |
| | | | Organic & Rubber |
| | | | Division |
| Antioxidant, | 0.5-2.5 | | Harwick |
| 1,2-dihydro-2, | | | |
| 2-4-trimethyl | | | |
| quinoline | | | |
| Processing Aid | 0.5-2.5 | VANFRE | R. T. Vanderbilt |
| | | AP-2 S.P. | |
| Peroxide | 0.5-2.5 | DICUP 40 K.E. | Hercules |
| Curing Agent | | | |

Useful processing aids include trans-polyoctanamer, polybutadiene, and VANFRE AP-2 SP. Processing aids generally lower mix viscosity and improve flow characteristics during extrusion and the like without significantly degrading properties (see Table 3) of the cured polymer (i.e., SBR) layer. Trans-polyoctanamer is a crosslinkable polymer that is made by metathesis polymerization of cylooctene, and typically comprises from about five to about ten percent by weight of the layer 12. Polybutadiene is also a crosslinkable polymer, and is made by polymerizing 1,3-butadiene in the presence of a stereo-specific catalyst. It may comprise from about three to about six percent by weight of the layer 12. VANFRE AP-2 SP is a proprietary processing aid manufactured by R. T. Vanderbilt, and may comprise from about 0.5 to about 2.5 percent by weight of the layer 12. Since the trans-polyoctanamer and polybutadiene are crosslinkable, they may tie into the SBR polymer network, which would help reduce migration of the processing aids within the layer 12 as the hose 10 ages.

As noted in Table 1, other components of the layer 12 may include curing activators, such as zinc oxide, and one or more antioxidants. Zinc oxide typically comprises from about one to about four percent by weight of the layer 12. The antioxidant, which helps increase heat resistance, typically comprises from about 0.5 to about 2.5 percent by weight of the layer 12. A useful antioxidant is 1,2-dihydro-2,2-4-trimethyl quinoline.

As noted above, the styrene butadiene component of the layer 12 is crosslinked using a peroxide curing agent. Any peroxide curing agent can be used as long as it is compatible with the components of the layer 12. Useful organic peroxides include dicumyl peroxide, 1,1-di-(tertbutylperoxy)-3,3,5-trimethylcylohexane, and other diacyl and dialkyl peroxides and peroxyketals. As shown in Table 1, a suitable organic peroxide is available from Hercules, Inc. under the trade name DiCup 40 K.E. Commercial preparations of peroxide curing agents are typically dispersed on a solid particulate carrier, such as clay, calcium carbonate, and the like. Thus, for example, DICUP 40 K.E. is a 40% active dicumyl peroxide supported on Burgess Clay. The peroxide typically ranges from about 0.5 to about 2.5 percent by weight of the layer 12, and is added in an amount necessary to properly crosslink the SBR. As indicated above, the peroxide curing agent may also crosslink trans-polyoctanamer and polybutadiene if present in the layer 12.

Although one or both of the intermediate and outer layers 14, 16 may have a composition similar to the inner layer 12, both layers 14, 16 typically include a base polymer that, when cured, exhibits better weather resistance and toughness than SBR. Useful base polymers include general-purpose neoprene (polychloroprene). Neoprene is available from a wide variety of suppliers, including Dupont Dow Elastomers, and is typically cured or crosslinked using a metallic oxide. Like the inner layer 12, the elastomeric inner 14 and outer 16 layers ordinarily include one or more particulate solid fillers (e.g., carbon black), processing aids, antioxidants, and the like.

As noted above, the first 18 and second 22 reinforcing layers typically comprise wound or braided fibers. Suitable fibers include those that exhibit the requisite strength for brake hose 10 applications, and which exhibit good adhesion to the elastomeric layers 12, 14, 16. A particular useful fiber includes a rayon fiber braid treated with resorcinol formaldehyde latex (RFL). Suitable RFL treated rayon fibers include those available from Mehler Engineering Products.

To prepare the brake hose 10, all of the components of the inner layer 12 except for the curing agent are charged to a mixer and blended at a temperature sufficient to ensure a fluid mixture. Once all of the components are consolidated, the curing agent is added to the mixture, and the resulting blend is supplied to an extruder. The blend is extruded through an annular die to form the inner layer 12 or core tube, which is covered by the first reinforcing layer 18, intermediate layer 14, and second reinforcing layer 22, using a braider or similar apparatus. To apply the intermediate layer 14, a calendered strip of elastomeric material is fed into the braider and is wrapped length-wise over the first reinforcing layer 18 as the braider applies the second reinforcing layer 22. Following application of the intermediate 14 and reinforcing layers 18, 22, the hose construction is introduced in a crosshead die of a second extruder, which applies the outer layer 16 onto the second reinforcing layer 22. The five-layer hose 10 is then cured in an oven, such an autoclave.

### EXAMPLE

The following example is intended to be illustrative and non-limiting, and represents a specific embodiment of the present invention.

All of the components listed in Table 2, except for the peroxide curing agent and one half of the carbon black, were added to a Banbury mixer and were mixed for one and a half minutes. The second half of the carbon black was added and the mixture was brought up to about 149° C. Following consolidation of the components, the peroxide curing agent was added to the mixture, which was mixed at temperatures not exceeding 110° C. After dispersing the peroxide curing agent, the mixture was delivered to an extruder. At the extruder, an inner layer or core tube was formed by extruding the mixture through an annular die onto a nylon cord. The inner tube then sat for three days to harden (partially cure).

A braider applied a first reinforcing layer, an elastomeric intermediate layer, and a second reinforcing layer in one operation. The first and second reinforcing layers were comprised of braided rayon fiber that was treated with RFL, and the elastomeric intermediate layer was comprised of a general-purpose neoprene rubber compounded with carbon black. The braid angle in both reinforcing layers ranged from about forty-eight degrees to about fifty-eight degrees with respect to the hose axis. The resulting hose construction was introduced into a crosshead die of a second extruder, which applied an outer elastomeric layer having the same composition as the elastomeric intermediate layer. The five-layer hose was then cured in an autoclave at 162° C. and 80 psi for about forty minutes. The resulting brake hose had an inner diameter of about 3.2 mm (⅛ inch) and an outer diameter of about 11 mm (0.43 inches).

TABLE 2
Composition of Inner Layer of the Example

| Component | Wt. % |
|---|---|
| SBR | 38% |
| Carbon Black | 35% |
| Silica | 8% |
| Poly-transoctanamer | 8% |
| Polybutadiene | 5% |
| Zinc Oxide, Antioxidant, VANFRE AP-2 S.P., | 6% |
| Peroxide Curing Agent | |

Table 3 lists physical properties of the brake hose. Samples of the hose either met or exceeded SAE J1401 (revised September 1999) specification for automotive hoses. Hardness, tensile strength, elongation, and adhesion were measured at room temperature (20° C.-25° C.); compression set was measured at 150° C. following forty-eight hours of compression. Mooney viscosity (ML1+4 121° C.) was measured following addition of the peroxide curing agent.

TABLE 3
Physical Properties of Hose Made
in Accordance with the Example

| Property | Test Result | |
|---|---|---|
| Shore A Hardness | 74 | Shore A |
| Tensile Strength | 16 | MPa |
| Elongation | 225% | |
| Mooney Viscosity | 80 | |
| Adhesion | >20 | lbs/in² |
| Compression Set | 34% | |
| Whip Test | 44 | hrs |
| Burst Test | 12,388 | psi |
| Volumetric Expansion | 0.14 | cc/ft at 1000 psi |
| | 0.18 | cc/ft at 1500 psi |
| | 0.35 | cc/ft at 2900 psi |

For comparison purposes, a hose containing SBR cured with a sulfur compound instead of a peroxide, resulted in an adhesion of approximately 5 lbs/in². As can be seen in Table 3, the SBR hose cured with peroxide exhibited adhesion greater than 20 lbs/in². The adhesion between the inner layer (core tube) and the first reinforcing layer was so strong that the hose having a peroxide-cured SBR core tube exhibited cohesive failure of the rubber. The improved adhesion is believed to be partly mechanical and partly chemical, but may result from other mechanisms as well.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled. The disclosures of all articles and reference, including patent applications and publications, if any, are incorporated herein by reference for all purposes.

What is claimed is:

1. A multilayer hose comprising:
an elastomeric core tube comprised of a peroxide-cured styrene butadiene rubber, the elastomeric core tube having an outer surface;
a first reinforcing layer bonded to the outer surface of the elastomeric core tube;
an elastomeric intermediate layer overlying the first reinforcing layer;
a second reinforcing layer overlying the elastomeric intermediate layer; and
an elastomeric outer layer overlying the second reinforcing layer.

2. The multilayer hose of claim 1, wherein the elastomeric core tube has a different composition than the elastomeric intermediate layer and the elastomeric outer layer.

3. The multilayer hose of claim 1, wherein the elastomeric intermediate layer and the elastomeric outer layer have the same composition.

4. The multilayer hose of claim 1, wherein the first and second reinforcing layers comprise rayon fibers treated with resorcinol formaldehyde latex.

5. The multilayer hose of claim 1, wherein the elastomeric intermediate layer and the elastomeric outer layer comprise neoprene rubber.

6. A multilayer hose comprising:
an elastomeric core tube comprising a peroxide-cured styrene butadiene rubber;
a braided reinforcing layer disposed on and bonded to the elastomeric core tube; and
an elastomeric outer layer overlying the braided reinforcing layer.

7. The multilayer hose of claim 6, wherein the elastomeric core tube has a different composition than the elastomeric outer layer.

8. The multilayer hose of claim 6, wherein the braided reinforcing layer comprises rayon fibers treated with resorcinol formaldehyde latex.

9. The multilayer hose of claim 6, wherein the elastomeric outer layer comprises neoprene rubber.

10 The multilayer hose of claim 6, wherein the hose further comprises an elastomeric intermediate layer disposed on the braided reinforcing layer.

11. The multilayer hose of claim 10, wherein the hose further comprises a second braided reinforcing layer disposed on the elastomeric intermediate layer.

12. A multilayer hose comprising:
an elastomeric core tube comprising styrene butadiene rubber, the styrene butadiene rubber comprising from about thirty to about fifty percent by weight of the core tube and being cured with a peroxide;
a first reinforcing layer bonded to an outer surface of the elastomeric core tube;
an elastomeric intermediate layer overlying the first reinforcing layer;
a second reinforcing layer overlying the elastomeric intermediate layer; and
an elastomeric outer layer overlying the second reinforcing layer.

13 The multilayer hose of claim 12, wherein the elastomeric core tube comprises from about thirty-five to about fifty percent by weight of one or more particulate fillers.

14. The multilayer hose of claim 12, wherein the elastomeric core tube includes from about 0.5 to about 18.5 percent by weight of one or more processing aids.

15. The multilayer hose of claim 12, wherein the elastomeric core tube includes from about eleven to about seventeen percent by weight of one or more processing aids.

16. The multilayer hose of claim 12, wherein the elastomeric core tube includes from about one to about four percent by weight of a curing activator.

17. The multilayer hose of claim 12, wherein the elastomeric core tube includes from about zero to about three percent by weight of an antioxidant.

18. The multilayer hose of claim 12, wherein the elastomeric core tube includes from about 0.5 to about three percent by weight of a peroxide curing agent.

19. The multilayer hose of claim 12, wherein the hose exhibits adhesion greater than about twenty pounds per square inch when tested in accordance with SAE J1401 rev. September 1999.

20. A multilayer hose comprising:
an elastomeric core tube comprising a peroxide-cured styrene butadiene rubber, the elastomeric core tube having an outer surface;
a first reinforcing layer bonded to the outer surface of the elastomeric core tube;
an elastomeric intermediate layer overlying the first reinforcing layer;
a second reinforcing layer overlying the elastomeric intermediate layer; and
an outer layer overlying the second reinforcing layer;
wherein the elastomeric core tube comprises from about thirty to about fifty percent by weight of styrene butadiene rubber, from about thirty-five to about fifty percent by weight of one or more particulate fillers, and from about 0.5 to about 18.5 percent by weight of one or more processing aids.
